(19) United States
(12) Patent Application Publication
(10) Pub. No.: US 2026/0233222 A1
(43) Pub. Date: Aug. 13, 2026

(54) BIOLOGICAL FLUID STORAGE DEVICES

(71) Applicant: Serpex Medical, Inc., Santa Clara, CA (US)

(72) Inventors: David MALLERY, Solana Beach, CA (US); Scott MORRIS, Phoenix, AZ (US)

(21) Appl. No.: 19/538,679

(22) Filed: Feb. 12, 2026

Related U.S. Application Data
(60) Provisional application No. 63/758,054, filed on Feb. 13, 2025.

(51) Int. Cl. B01L 3/00

(52) U.S. Cl. CPC B01L 3/502715; B01L 3/502; B01L 3/508; B01L 2300/0681

(57) ABSTRACT

Biological fluid storage devices are described herein. In some embodiments, a biological fluid storage device comprises a sample compartment, a desiccant compartment, and a coupler. The sample compartment is configured to contain a sample portion of a biological fluid collection substrate. The sample portion contains a biological fluid sample. The desiccant compartment is in fluid communication with the sample compartment. The desiccant compartment is configured to contain a desiccant such that moisture is transferrable from the sample portion in the sample compartment to the desiccant in the desiccant compartment. The coupler is configured to couple the storage device to an external receptacle such that the sample portion containing the sample can be transferred from the sample compartment to the external receptacle.

### CROSS REFERENCE TO RELATED APPLICATION

This application claims priority to U.S. Provisional Patent Application No. 63/758,054, filed Feb. 13, 2025, and titled “BIOLOGICAL FLUID STORAGE DEVICES,” the contents of which are incorporated by reference herein in its entirety.

### TECHNICAL FIELD

The present disclosure relates to biological fluid storage devices, and in particular to devices and methods for storing, drying, preserving, and/or transporting of biological fluid samples for subsequent testing.

### BACKGROUND

Biological samples such as blood samples are routinely collected and analyzed to assess the overall physical well-being of patients. Liquid blood samples in particular are often either tested shortly after collection or subjected to multiple preparation and/or processing steps including, for example, sorting, clotting, centrifuging, refrigeration preparation and/or processing steps to preserve the samples for subsequent testing. Such steps often require expensive and complex equipment.

Another blood sample collection technique includes dried blood spot (DBS) sampling in which a sample of blood is collected on a substrate, e.g., an absorbent paper, a filter paper, etc., and dried. Once dried, analytes such as DNA, RNA, proteins, and small molecules are stable at ambient temperature and/or under refrigeration for years, and so the dried samples can be stored for extended periods of time with little to no deterioration of the analytes, and can safely and relatively easily be transported to a laboratory for testing.

The blood sample can be dried by exposing the paper to the environment for evaporation or storing the paper near solid desiccant or other material that dries or maintains dryness of the sample by absorbing moisture. Exposure of the paper to the various environments having variable ambient conditions, and/or surfaces during drying or shipment, can result in sample contamination and inconsistent test results. Further, current techniques involve physical handling of the DBS, e.g., during collection, and during testing by a lab technician, risking the sterility and effectiveness of the testing as well as the quality of the blood sample. The technique also often includes use of several tools, e.g., a hole punch, tweezers, pipette, etc., each of which requires cleaning and/or replacement between uses.

Therefore, there is a need to develop devices and methods that can reduce physical handling of biological fluid collection substrates containing biological fluid samples to improve sample quality. There is also a need to develop devices and methods to simplify and enable repeatable collection, drying, and transporting of biological fluids, without e.g., comprising sample quality due to variable or extreme ambient conditions.

### SUMMARY

Biological fluid storage devices are described herein. In some embodiments, a biological fluid storage device comprises a sample compartment, a desiccant compartment, and a coupler. The sample compartment is configured to contain a sample portion of a biological fluid collection substrate. The sample portion contains a biological fluid sample. The desiccant compartment is in fluid communication with the sample compartment. The desiccant compartment is configured to contain a desiccant such that moisture is transferrable from the sample portion in the sample compartment to the desiccant in the desiccant compartment. The coupler is configured to couple the storage device to an external receptacle such that the sample portion containing the sample can be transferred from the sample compartment to the external receptacle, e.g., without additional tools.

In some embodiments, a biological fluid storage device includes a cutter, a sample compartment, and a desiccant compartment. The cutter is configured to separate a sample portion of a biological fluid collection substrate containing a biological fluid sample from a user handling portion of the substrate. The sample compartment is configured to contain the sample portion containing the fluid sample. The desiccant compartment is in fluid communication with the sample compartment. The desiccant compartment is configured to contain a desiccant such that moisture is transferrable from the sample portion in the sample compartment to the desiccant in the desiccant compartment.

In some embodiments, a method includes positioning a sample portion of a biological fluid collection substrate in a sample compartment of a biological fluid storage device. The sample portion can carry a biological fluid sample (e.g., blood). The sample compartment is in fluid communication with a desiccant compartment of the biological fluid storage device. The desiccant compartment includes a desiccant such that moisture is encouraged to transfer from the sample portion in the sample compartment to the desiccant in the desiccant compartment. The method further includes separating the sample portion from a user handling portion of the biological fluid collection substrate and sealing the sample compartment.

In some embodiments, a method includes removing a biological fluid collection storage device from a packaging. The biological fluid collection storage device includes a sample compartment with a sample substrate positioned therein, and the sample substrate contains a biological fluid sample. The storage device includes a desiccant compartment with a desiccant positioned therein, and the desiccant compartment is in fluid communication with the sample compartment to cause the desiccant to absorb at least some moisture from the sample substrate. The method further includes coupling an external receptacle to the biological fluid collection storage device (e.g., via a coupler), and maneuvering (e.g., inverting) the sample compartment to cause the sample substrate to transfer from the sample compartment to the external receptacle.

In some embodiments, a kit includes a biological fluid collection substrate, a biological fluid storage device, and a packaging. The biological fluid collection substrate may include an interface to facilitate separation of a sample portion of the biological fluid collection substrate from a user handling portion of the biological fluid collection substrate. The sample portion is configured to carry a biological fluid sample. The biological fluid storage device is configured to receive the sample portion. The biological fluid storage device has a desiccant compartment in fluid communication with the sample portion such that moisture is transferrable from the sample portion to desiccant in the desiccant compartment. The packaging is configured to enclose the biological fluid storage device.

### BRIEF DESCRIPTION OF THE DRAWINGS

FIG. 1A is a schematic illustration of a biological fluid collection substrate for collection of biological fluid samples, according to an embodiment.

FIG. 1B is a schematic illustration of a biological fluid storage device for the storage of biological fluid samples, according to an embodiment.

FIG. 2A is a perspective view of a biological fluid storage device in a at least partially disassembled configuration, according to an embodiment.

FIG. 2B is a perspective view of a portion of the biological fluid storage device of FIG. 2A, according to an embodiment.

FIG. 2C is a side view of the portion of the biological fluid storage device of FIG. 2B, according to an embodiment.

FIG. 2D is a perspective, cutaway view of the portion of the biological fluid storage device of FIG. 2B, according to an embodiment.

FIG. 2E is another perspective view of the biological fluid storage device of FIG. 2A, according to an embodiment.

FIG. 3 shows desiccant at varying levels of moisture, and that can be included in any of the biological fluid storage devices disclosed herein, according to an embodiment.

FIG. 4A is a side view of another biological fluid storage device, according to an embodiment.

FIG. 4B is a side view of another biological fluid storage device, according to an embodiment.

FIG. 5 is a flow diagram showing a loading process of the biological fluid storage device of FIGS. 2A-3A, according to an embodiment.

FIGS. 6A-6C show a sample collection process and use of the biological fluid storage device of FIGS. 2A-3A, according to an embodiment.

FIGS. 7A-7C show a substrate retrieval process of the biological fluid storage device of FIGS. 2A-3A, according to an embodiment.

FIG. 8 is a flowchart of an example method of operating and/or using a biological fluid storage device, according to an embodiment.

### DETAILED DESCRIPTION

The embodiments described herein relate generally to biological fluid storage devices, and in particular to devices and methods for storing, drying, preserving, and transporting biological fluid samples, such as DBS samples.

Collection and processing of blood samples for use in clinical diagnostics can be complex. DBS samples, for example, can be drawn from patients and then be subjected to multiple processing steps performed by medical professionals and/or technicians to prepare and stabilize blood sample specimens until they are transferred to and after receipt at a laboratory for analysis. Typically, blood samples are dried to produce small, transportable blood samples for subsequent testing. Dried blood samples are more stable than liquid blood, more cost-effective, and less invasive. However, challenges may arise during collection, storage, and/or transportation of dried blood samples. Medical professionals and/or technicians may be highly trained, but human error and ambient conditions, e.g., during transport, risks the sterility and quality of dried blood samples which, in turn, can lead to skewed test results or unusable samples. Current methods also include additional tools, e.g., single use and/or reusable tools, which require sterilization, increasing the complexity and expense of such methods.

Systems and devices described herein address the limitations of existing technologies by providing a biological fluid storage or preservation device that reduces manual manipulation, dries, and/or preserves quality of biological fluid samples, such as blood samples collected on substrates. In some implementations, the systems and devices described herein can be configured to receive, store, dry, preserve, stabilize, etc., blood samples disposed on such biological fluid collection substrates. In some implementations, the systems and devices described herein can be configured to receive biological fluid samples disposed on biological fluid collection substrates, separate or disconnect portions of the substrates containing the samples from portions of the substrates exposed to human contact or similar contact that may pose a contamination risk, preserve, e.g., dry and seal from environment, the sample, and accommodate simplified sterile removal of the sample for subsequent testing.

As used in this specification and/or any claims included herein the singular forms “a,” “an,” and “the” include plural referents unless the context clearly dictates otherwise. Thus, for example, the term “a member” is intended to mean a single member or a combination of members, “a material” is intended to mean one or more materials, and/or the like.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein, the terms “about,” “approximately,” and/or “substantially” when used in connection with stated value(s) and/or geometric structure(s) or relationship(s) is intended to convey that the value or characteristic so defined is nominally the value stated or characteristic described. In some instances, the terms “about,” “approximately,” and/or “substantially” can generally mean and/or can generally contemplate a value or characteristic stated within a desirable tolerance, e.g., plus or minus 10% of the value or characteristic stated. For example, a value of about 0.01 can include 0.009 and 0.011, a value of about 0.5 can include 0.45 and 0.55, a value of about 10 can include 9 to 11, and a value of about 1000 can include 900 to 1100. Similarly, a first surface may be described as being substantially parallel to a second surface when the surfaces are nominally parallel. While a value, structure, and/or relationship stated may be desirable, it should be understood that some variance may occur as a result of, for example, manufacturing tolerances or other practical considerations (such as, for example, the pressure or force applied through a portion of a device, conduit, lumen, etc.). Accordingly, the terms “about,” “approximately,” and/or “substantially” can be used herein to account for such tolerances and/or considerations.

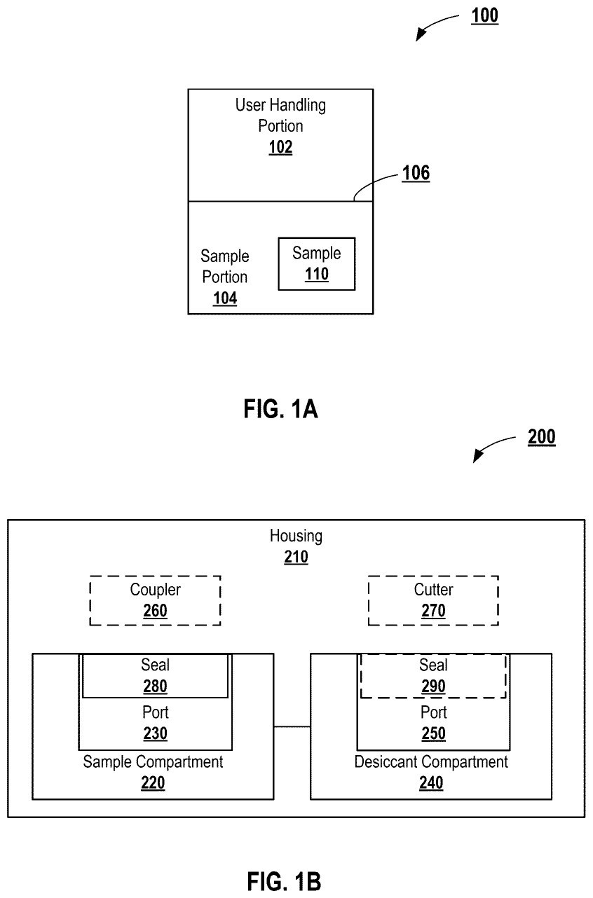

FIG. 1A shows a schematic illustration of a biological fluid collection substrate 100 (also referred to herein as “substrate”) for the collection of a biological fluid sample 110 (also referred to herein as “sample”), according to an embodiment. The substrate 100 can be any suitable surface, layer, material, substructure, etc., configured to gather, absorb, bind to, support, receive, retrieve, and/or otherwise collect and/or store a biological fluid sample, such as blood. The substrate 100 can be sterile or configured to be sterilized for single use, in some embodiments.

The substrate 100 includes a user handling portion 102, a sample portion 104, and an interface 106 disposed between the user handling portion 102 and the sample portion 104. In some embodiments, the substrate 100 is paper, such as absorbent paper or filter paper. In some embodiments, the substrate 100 is a generally rectangular shape. However, the substrate 100 can be any suitable shape, e.g., circular, ovular, triangular, etc., or combination of shapes. In some embodiments, the substrate 100 is approximately flat, e.g., having a thickness of less than 0.5 millimeters (mm).

The user handling portion 102 is a section, end, corner, area, layer, appendage, extension, etc., of the substrate 100. For example, if the substrate 100 is paper, then the user handling portion 102 is a section, end, corner, area, layer, appendage, extension, etc., of the paper. The user handling portion 102 can be part of and/or integral to the remainder of the substrate 100 or formed separately and then coupled to the remainder of the substrate 100. The user handling portion 102 is configured to receive or be manipulated by a tool, a hand of a user, fingers of a user, etc. Further, the user handling portion 102 is configured to be manipulated to control movement of the substrate 100 and, thus, the sample 110. For example, a tool can contact and/or grip the user handling portion 102 to manipulate the substrate 100. Alternatively or additionally, a hand of a user, e.g., lab technician, can contact and/or grip the user handling portion 102 to manipulate the substrate 100, e.g., for sample collection and/or transport.

The sample portion 104 is a section, end, corner, area, layer, appendage, extension, etc., of the substrate 100. For example, if the substrate 100 is paper, then the sample portion 104 is a section, end, corner, area, layer, appendage, extension, etc., of the paper. The sample portion 104 can be part of and/or integral to the substrate 100, or formed separately and then coupled to the remainder of the substrate 100. The sample portion 104 is configured to receive and retain the sample 110. In some embodiments, the sample 110 covers, e.g., completely covers, the sample portion 104. In some embodiments, the sample 110 at least partially covers the sample portion 104. In some embodiments, the sample 110 covers at least one side of the sample portion 104. In some embodiments, the sample portion 104 retains the sample 110 within fibers of an absorbent material making up the sample portion 104.

In use, in some implementations, the sample portion 104 can be disposed within an external storage component, e.g., test tube, containing the sample 110 to facilitate collection of the sample 110, storage of the sample 110, and/or testing of the sample 110. In some such embodiments, the sample portion 104 can include an indicator or other marking that indicates a minimum or threshold amount of the sample 110 to retrieve from the external storage component. For example, the sample portion 104 can include a line, dash, notch, etc., that can provide a visual indication of how far to dispose the substrate 100 into the external storage component for retrieval of the threshold amount of sample 110. In some implementations, the sample 110 is contained within a syringe, pipette, or similar sample storage such that the sample 110 can be disposed, dropped, and/or otherwise transported from such sample storage to the sample portion 104. A user, such as a medical professional or technician, can facilitate collection of the sample 110 by grabbing, pinching, and/or holding the user handling portion 102 of the substrate 100 to maneuver the sample portion 104 to collect the sample 110. In some embodiments, the sample portion 104 can be configured to be disposed within an external storage compartment (e.g., test tube) after sample 110 collection, e.g., for testing or subsequent testing of the sample 110. In some such embodiments, for example, the sample portion 104 may be shaped and/or sized to fit within, mate with, or otherwise correspond to a shape and/or size (or feature therein) of a test tube. In some instances, for example, the sample portion 104 may be or include a triangular shape configured to fit within or mate with a triangular, V-shape, conical, etc., feature within the test tube.

In FIG. 1A, the user handling portion 102, the sample portion 104, and the interface 106 collectively take up an entirety of the substrate 100, but in some embodiments, the user handling portion 102, the sample portion 104, and the interface 106 may take up only part of the substrate 100. In other words, the substrate 100 can have other portions not shown. In some embodiments, the user handling portion 102 is approximately half an area, cross-sectional areal, a length, a width, a span, etc., of the substrate 100 and the sample portion 104 is approximately half of the substrate 100. In some embodiments, a size or span of the user handling portion 102 is different from, e.g., larger than, smaller than, etc., the sample portion 104. Although shown as including one sample portion 104, one sample 110, and one user handling portion 102, the substrate 100 can include any number of the sample portion 104, the sample 110, or the user handling portion 102.

The interface 106 is a location, area, point, and/or region of the substrate 100 disposed between, separating, or otherwise indicating a limit or boundary of the user handling portion 102 and the sample portion 104. In some embodiments, the interface 106 indicates (e.g., visually) a transition between the user handling portion 102 and the sample portion 104. In some embodiments, the interface 106 is configured to facilitate physical separation of the user handling portion 102 from the sample portion 104. In some such embodiments, the interface 106 includes one or more features or characteristics configured to induce one or more stress concentration points. The interface 106 can have any suitable material characteristic, shape, orientation, and/or other features that define a stress concentration point on or within the substrate 100, e.g., to enable physical separation between the user handling portion 102 and the sample portion 104. For example, the interface 106 can be a material that is weaker than material(s) forming or otherwise associated with the sample portion 104 and/or the user handling portion 102, thereby inducing a stress concentration point on the substrate 100 at the interface 106. Additionally or alternatively, the interface 106 can be a portion of the substrate 100 that is thinner, narrower, tapered, etc., relative to the sample portion 104 and the user handling portion 102 thereby inducing a stress concentration point on the substrate 100 at the interface 106. Further, the interface 106 can include or define features, e.g., one or more perforations or fractures, which induce a stress concentration point on the substrate 100 at the interface 106, thereby enabling disconnection or decoupling, as described above. In some embodiments, for example, stress, e.g., contact, force, etc., exerted on the interface 106 causes physical separation of the sample portion 104 from the user handling portion 102.

In use, for example, a user can manipulate the user handling portion 102 to collect the sample 110 on the sample portion 104, without direct contact by the user with the sample portion 104, thereby preserving sterility or otherwise limiting contamination of the sample portion 104 and/or sample 110, and subsequently separating the sample portion 104 from the user handling portion 102 for storage and/or processing of the sample 110, as described in further detail herein.

FIG. 1B shows a schematic illustration of a biological fluid storage device 200 (also referred to herein as “device 200”) configured for the storage, drying, preservation, and transport of biological fluid samples, according to an embodiment. The device 200 can be configured to receive, store, dry, transfer, etc., one or more biological fluid samples, e.g., the sample 110. The device 200 includes a housing 210 including or defining a sample compartment 220, a port 230 operably coupled to or defined by the sample compartment 220, a desiccant compartment 240, a port 250 operably coupled to or defined by the desiccant compartment 240, and a seal 280. Optionally, in some embodiments, the housing 210 can also include or define a coupler 260, a cutter 270, and/or a seal 290 for the port 250. Although shown as including one sample compartment 220, one port 230, one desiccant compartment 240, one port 250, one coupler 260, one cutter, one seal 280, and one seal 290, in some embodiments, the housing 210 can include any number of sample compartments 220, ports 230, desiccant compartments 240, the port 250, couplers 260, cutters, seals 280, and/or seals 290.

The housing 210 can be any suitable structure configured to provide a protective enclosure that defines one or more interior volumes, compartments, and/or chambers suitable for accommodating the components of the device 200. The housing 210 can be any suitable shape or configuration for accommodating, housing, enclosing, and/or supporting the one or more components of the device 200. For example, the housing 210 can be cubic, cuboid, polyhedral and/or any other suitable geometric shape. In some embodiments, the housing 210 can include multiple portions that can be coupled and/or assembled together to form one or more chambers and/or compartments for receiving the components of the device 200. That is, in some embodiments, the housing 210 can be modular. Alternatively, in some embodiments, the housing 210 can be made of a monolithic structure. Further, the housing 210 can also define one or more interfaces that provide mechanical support to one or more external components. The housing 210 can define one or more interior volumes, compartments, and/or chambers suitable for accommodating the sample compartment 220 and the desiccant compartment 240. Further, the housing 210 can define one or more interfaces configured to receive, couple, and/or decouple the cutter 270, the coupler 260, and/or the seal 280 to the device 200.

The sample compartment 220 is a volume, area, chamber, etc., configured to receive and contain a biologic fluid sample, and/or substrate containing a biological fluid sample, e.g., the sample portion 104 containing the sample 110. In some embodiments, the sample compartment 220 is integral to the housing 210. The sample compartment 220 can be a portion of the housing 210 defined by walls, structures, corners, boundaries, etc., of the housing 210. In some embodiments, the sample compartment 220 is configured to contain, store, support, and/or house the sample 110 and/or the sample portion 104 containing the sample 110. For example, the sample compartment 220 is configured to receive and/or contain the sample portion 104 containing the sample 110. In some embodiments, the sample compartment 220 is dimensioned to receive the sample portion 104, e.g., only the sample portion 104 or multiple sample portions 104. For example, the sample compartment 220 may contain the sample portion 104 by enclosing, surrounding, etc., the sample portion 104. In some embodiments, the sample compartment 220 is dimensioned to receive at least some of the sample portion 104. In some embodiments, the sample compartment 220 is dimensioned to receive the sample portion 104 and at least some (or all) of the user handling portion 102. In some embodiments, the housing 210 can include multiple sample compartments 220 to contain multiple sample portions 104 having the same or different samples 110, e.g., each sample compartment may contain one or more samples or sample portions.

The port 230 is a channel, slot, aperture, etc., configured to facilitate access to or from the sample compartment 220 from outside the sample compartment 220 and/or from outside the housing 210. In some embodiments, the port 230 is a channel, slot, aperture, etc., in the housing 210 that extends from the sample compartment 220 to or through an external surface of the housing 210. In use, the port 230 enables the sample portion 104 to be positioned within and removed from the sample compartment 220. For example, the port 230 can provide the sample portion 104 with access to the sample compartment 220. Further, the port 230 is configured to be sealed or unsealed to seal or otherwise isolate the sample compartment 220 (e.g., having the sample portion 104 disposed within the sample compartment 220) from an environment external to the housing 210.

In some instances, it may be desirable to have the sample compartment 220 receive and contain the sample portion 104 but exclude the user handling portion 102 (e.g., to reduce the overall form factor, because the user handling portion 102 is no longer needed, and/or to exclude a potentially contaminated user handling portion, thereby preserving the quality of the sample 110). Accordingly, in some embodiments, as described above, the sample portion 104 may be separated from the user handling portion 102 (at the interface 106) such that the sample portion 104 is inserted into the sample compartment 220, and the user handling portion 102 is not.

The user handling portion 102 can be removed from the sample portion 104 in any suitable manner. In some embodiments, for example, in use, when the user handling portion 102 is still coupled with the sample portion 104 and the sample portion 104 is positioned within the sample compartment 220, e.g., via the port 230, the user handling portion 102 extends away from and outside the sample compartment 220 and the housing 210, and then the user handling portion 102 can be separated from the sample portion 104. In some embodiments, when the sample portion 104 is positioned within the sample compartment 220, the interface 106 may be spaced from the sample compartment 220 and/or the port 230 such that the interface 106 is accessible to facilitate separation. In some instances, for example, a user can pull on or otherwise apply tension to the user handling portion 102 to separate from the sample portion 104 when the user handling portion 102 extends away from the sample compartment 220 and/or the port 230. In some embodiments, the housing 210 may include a cutter 270 to facilitate such separation. In such embodiments, the cutter 270 can be configured to cut or otherwise cause separation, disconnection, decoupling at the interface 106 between the user handling portion 102 and the sample portion 104. The cutter 270 can be any suitable size and/or shape and can use any suitable manner to separate the user handling portion 102 from the sample portion 104. The cutter 270 can be integral to the housing 210 or formed separately and then coupled to (or removably, fixedly, and/or slidably coupled to) the housing 210. The cutter 270 can be located or disposable in any suitable location on, within, and/or relative to the housing 210. In some embodiments, for example, the sample compartment 220, port 230, housing 210, and/or the cutter 270 can be collectively configured such that when the sample portion 104 is disposed within the sample compartment 220, the interface 106 is disposed at or near, or otherwise aligned or alignable relative to the cutter 270 such that the interface 106 is accessible to the cutter 270 to facilitate separation of the user handling portion 102 while the sample portion 104 remains in the sample compartment 220.

For example, the cutter 270 can have one or more corners, edges, tapered surfaces, etc., that enable the cutter 270 to cut, e.g., a biological fluid collection substrate, such as the interface 106 of substrate 100. In some embodiments, the cutter 270 includes a material or other material characteristics that enables the cutter 270 to cut. For example, the cutter 270 can have a material hardness stronger than a material hardness of another component (e.g., the interface 106) such that contact between the cutter 270 and the component causes the component to separate. In some embodiments, the cutter 270 is immovably fixed to or integral to the housing, and during use, the interface 106 can be brought into contact with the cutter 270 for separation. In some embodiments, the cutter 270 is movable relative to the housing 210 to facilitate this separation. For example, the cutter 270 can translate, rotate, slide, vibrate, etc., to cause separation.

In use, the cutter 270, e.g., separator, decoupler, disconnector, etc., can be used to cause separation of the sample portion 104 from the substrate 100. The cutter 270 for example can be configured to separate the sample portion 104 from the substrate 100 when the sample portion 104 is positioned within the sample compartment 220. In some embodiments, the cutter 270 is configured to separate the sample portion 104 from the substrate 100 by contacting the interface 106. In some embodiments, at least portion of the cutter 270 contacts and/or extends from the housing 210 to enable alignment between the cutter 270 and the interface 106. For example, an external surface of the housing 210 may be aligned with (e.g., be parallel to) the interface 106 when the sample portion 104 is positioned within the sample compartment 220. The cutter 270 can slide along, rotate relative to, or otherwise move to contact this external surface to align with the interface 106 prior to and during contacting the interface 106 to facilitate cutting of the substrate 100.

The desiccant compartment 240 is a volume, area, chamber, etc., configured to receive and contain a desiccant (e.g., a solid desiccant). The desiccant compartment 240 can be integral to the housing 210 or formed separately and then coupled to the housing 210. In some embodiments, the desiccant compartment 240 is a portion of the housing 210 and defined by walls, structures, corners, boundaries, etc., of the housing 210. For example, the desiccant compartment 240 is configured to receive and/or contain desiccant and/or other material that dries or maintains dryness by absorbing moisture, e.g., ambient moisture and/or moisture contained in the biological sample (e.g., sample 110) and/or substrate 100. In some embodiments, the housing 210 can include multiple desiccant compartments 240 to contain multiple desiccants. In some embodiments, the number of desiccant compartments 240 corresponds to or matches the number of sample compartments 220. For example, each sample compartment 220 can be paired with a corresponding, single desiccant compartment 240. Alternatively, in some embodiments, the number of desiccant compartments 240 is different than the number of sample compartments 220. For example, there may be one or more desiccant compartments 240 paired with one or more sample compartments 220.

The desiccant compartment 240 is in fluid communication with the sample compartment 220 to facilitate transfer of moisture (e.g., water vapor) from the sample compartment 220 to the desiccant compartment 240, even when the housing 210 is sealed relative to the external, ambient environment. Such fluid communication can be accommodating in any suitable manner, for example, in some embodiments, the desiccant compartment 240 is in fluid communication with the sample compartment 220 via a channel, slot, tube, vessel, pipe, etc., defined by and/or within the housing 210 and configured to allow fluid communication therethrough. In some embodiments, the housing 210 includes walls or surfaces between the desiccant compartment 240 and the sample compartment 220. Such walls or surfaces may include one or more channels, slots, openings, etc., that fluidly couple the desiccant compartment 240 and the sample compartment 220. Therefore, moisture is transferrable/encouraged to transfer from the sample portion 104 in the sample compartment 220 to the desiccant in the desiccant compartment 240 based on these fluid communication channels. In other words, moisture from the sample 110 disposed on the sample portion 104 traverses the channel, slot, tube, vessel, pipe, etc., facilitating fluid communication between the sample compartment 220 and the desiccant compartment 240 to bind with and/or become absorbed by the desiccant in the desiccant compartment 240. In some embodiments, such walls or surfaces may provide surfaces against which the desiccant in the desiccant compartment 240 and/or the sample (or substrate containing the sample) in the sample compartment 220 can abut. Such walls or surfaces, e.g., can form or define part of the sample compartment 220 and/or the desiccant compartment 240.

In embodiments in which the housing 210 includes more than one sample compartment 220 and/or more than one desiccant compartment 240, fluid communication between the one or more sample compartments 220 and the one or more desiccant compartments 240 can have any suitable combination. For example, a single desiccant compartment 240 may be in fluid communication with multiple sample compartments 220; a single sample compartment 220 may be in fluid communication with multiple desiccant compartments 240; and/or a first sample compartment may be in fluid communication with a first desiccant compartment and a second sample compartment may be in fluid communication with a second desiccant compartment.

Further, the sample compartment 220 can be arranged in any suitable position or orientation relative to the desiccant compartment 240. In some embodiments, for example, the desiccant compartment 240 may be next to and/or laterally spaced from the sample compartment 220. In some embodiments, the desiccant compartment 240 may circumferentially surround (completely or partially) the sample compartment 220 to facilitate moisture transfer therebetween.

In some implementations, at least a portion of the desiccant can be configured to indicate a moisture level of the desiccant and/or, by extension and/or inference, a dryness of the sample portion 104. Upon absorption of moisture, for example, at least a portion of the desiccant in the desiccant compartment 240 may change color. In other words, a color, or a change in color of the at least a portion of the desiccant can indicate a moisture level or concentration of the desiccant. For example, a first color, e.g., blue, of at least a portion of the desiccant can indicate that the desiccant has absorbed little to no moisture and a second color, e.g., red, of at least a portion of the desiccant can indicate that the desiccant has absorbed a threshold amount of moisture. In use with the device 200, the at least a portion of the desiccant having the second color can indicate that the desiccant has absorbed (i) a threshold amount of moisture from the sample portion 104 or (ii) a threshold amount of moisture from another source, e.g., the ambient environment of the device 200, an empty sample compartment 220, etc. Desiccant having the second color may not be usable. Specifically, once the desiccant has absorbed the threshold amount of moisture such that the desiccant is the second color, the desiccant may need to be replaced by a desiccant of the first color such that the sample portion 104 can dry.

In some embodiments, the desiccant compartment 240 includes a first desiccant and a second desiccant. The first desiccant can include a first material and/or a first chemical composition different from a second material and/or a second chemical composition of the second desiccant. Accordingly, the first desiccant may indicate its moisture level or concentration by having a color or changing in color based on the first material and/or the first chemical composition. Further, the second desiccant may not indicate its moisture level or concentration by having a color or changing in color based on the second material and/or the second chemical composition. The desiccant compartment 240 can include at least some amount of the first desiccant (e.g., for purposes of indication by color) mixed in with, positioned next to, or otherwise included with the second desiccant. For example, the first and second desiccant may be positioned in one or more layers. The desiccant compartment 240 can include a first amount (e.g., weight, quantity, etc.) of the first desiccant and a second amount of the second desiccant, the second amount being different from (e.g., greater than or less than) the first amount. Alternatively, the first amount of the first desiccant may be about the same (e.g., within 5%) as the second amount of the second desiccant. In some embodiments, when the housing 210 includes more than one of the desiccant compartment 240, at least one of the desiccant compartments 240 can include at least some of the first desiccant. In some embodiments, the first desiccant is or includes silicon. In some embodiments, the second desiccant is or includes a molecular sieve (e.g., 3 angstrom (3A)).

In some embodiments, a portion of the housing 210 and/or the desiccant compartment 240 may be transparent such that at least some of the desiccant (e.g., the first desiccant having first material and/or first chemical composition enabling color changing) is visible through the transparent portion of the housing 210 and/or the desiccant compartment 240. Thus, when the threshold amount of moisture has been absorbed such that the desiccant has changed color, the transparent portion of the housing 210 can enable an external perspective, e.g., a user, a camera, an external scanning device, etc., of the device 200 to observe and/or record this change in color. In some embodiments, the transparent portion of the housing 210 is adjacent to and/or surrounding the desiccant compartment 240. For example, the transparent portion of the housing 210 may be a window, panel, etc., made of glass, plastic, etc. Additionally or alternatively, the transparent portion of the housing 210 may surround the housing 210, e.g., in a ring-like manner, in a C shape, etc. In some embodiments, the transparent portion of the housing 210 may cover an entirety of the desiccant compartment 240 such that substantially all, e.g., within 5%, of the desiccant is visible from an external perspective of the device 200.

The port 250 is a channel, slot, aperture, etc., configured to facilitate access to or from the device 200. In some embodiments, the port 250 extends from an external surface of the device 200 to an internal compartment of the device 200 to provide access thereto. For example, the port 250 provides access to the desiccant compartment 240 from outside the desiccant compartment 240 and/or from outside the housing 210. In some embodiments, the port 250 is a channel, slot, aperture, etc., in the housing 210 that extends from the desiccant compartment 240 to or through an external surface of the housing 210. In use, the port 250 enables the desiccant to be positioned within the desiccant compartment 240. Put differently, the desiccant can be disposed, inserted, remove from, etc., within the desiccant compartment 240 via the port 250. In some embodiments the port 250 may be secured (e.g., irreversibly secured) so that the desiccant compartment 240 is not accessible by a user of the device 200, whereas in some embodiments the port 250 may be selectively sealed to block access and unsealed to permit access to the desiccant compartment, e.g., so a user can insert, remove, and/or relace desiccant to/from the desiccant compartment 240.

The seal 290 is configured to close, seal, isolate, etc., the desiccant compartment 240 from the ambient environment of the device 200. In this manner, with the seal 290 in an unsealed configuration, a desiccant can be inserted into the desiccant compartment 240 through the port 250, and then the seal 290 can transition to a sealed configuration to limit or prevent access to the desiccant compartment 240 through the port 250 to secure and/or seal (e.g., fluidically) the desiccant within the desiccant compartment 240, e.g., to preserve desiccant quality, from the ambient environment, etc. The seal 290 can be a cover, lid, gate, slider, button, plug, etc., or any other component configured to seal and unseal access to the desiccant compartment 240. The seal 290 can be movable relative to the housing 210 and/or the port 250 such that the desiccant compartment 240 can be selectively sealed or unsealed (i.e., reversibly sealed). In some embodiments, the seal 290 can engage with the housing 210 via a threaded connection, press-fit connection, or interference fit connection to seal the desiccant compartment 240 from the ambient environment. In some embodiments, the seal 290 is coupled or attached to the housing 210 while being removably coupled to the desiccant compartment 240. In some embodiments, the seal 290 can be configured to be transitioned between its sealed configuration or position and its unsealed configuration or position by a user of the device 200, while in some embodiments the seal 290 is configured to be effectively irreversibly sealed such that after the desiccant is introduced through the port 250 and into the desiccant compartment 240 with the seal 290 in its unsealed configuration or position, the seal 290 can be permanently or at least securely (e.g., requiring a particular tool or key to unseal) transition to its sealed configuration or position.

The seal 280 is configured to close, seal, isolate, etc., the sample compartment 220 from the ambient environment of the device 200. In this manner, with the seal 280 in an unsealed configuration, a collected sample (e.g., sample 110) can be inserted into the sample compartment 220 through the port 230, and then the seal 280 can transition to a sealed configuration to limit or prevent access to the sample compartment 220 through the port 230 to secure and/or seal (e.g., fluidically) the sample within the sample compartment 220 to preserve sample quality and allow transfer of moisture from the sample compartment 220 to the desiccant compartment 240. The seal 280 can be a cover, lid, gate, slider, button, plug, etc., or any other component configured to seal and unseal access to the sample compartment 220. The seal 280 can be movable relative to the housing 210 and/or the port 230 such that the sample compartment 220 can be selectively sealed or unsealed (i.e., reversibly sealed). The seal 280 can be moveably coupled to the housing 210 in any suitable manner, e.g., the seal 280 and the housing 210 can have cooperating coupling features, such as a rail and protrusion, hinge (e.g., living hinge), etc. The seal 280 can be formed separately from the housing 210 and then coupled to the housing 210, or the seal 280 and the housing 210 may be integral, in some embodiments. For example, the seal 280 is configured to be removed or separated from at least the sample compartment 220 such that the sample compartment 220 is unsealed and enabled to receive the sample portion 104. In some embodiments, the seal 280 is coupled or attached to the housing 210 while being removably coupled to the sample compartment 220. The seal 280 is configured to cover and/or plug the port 230, to seal the sample compartment 220 from the ambient environment. In some embodiments, the seal 280 is couplable or attachable to the port 230 to facilitate the sealing. When the sample portion 104 is positioned within the sample compartment 220 and the sample compartment 220 is covered by the seal 280, the seal 280 is configured to seal or isolate the sample portion 104 from the ambient environment. Prior to positioning the sample portion 104 within the sample compartment 220, the seal 280 can cover or plug the sample compartment 220 to seal the desiccant in the desiccant compartment 240 based on the sample compartment 220 being fluidly coupled with the desiccant compartment 240. As such, the seal 280 can preserve the absorptive quality of the desiccant in the desiccant compartment 240 by sealing the desiccant from the ambient environment of the device 200, e.g., before use. Put differently, the seal 280 can limit or prevent the desiccant from absorbing moisture from the ambient environment prior to disposal of the sample portion 104 in the sample compartment 220.

In some embodiments, the seal 280 includes, is coupled to, or defines the cutter 270. In some implementations, for example, the cutter 270 may be integral to the seal 280. For example, the cutter 270 may be a sharp surface, e.g., corner, edge, side, etc., of the seal 280 such that actuation or movement of the cutter 270 and the seal 280 can simultaneously seal the sample compartment 220 and separate the user handling portion 102 from the sample portion 104. In some embodiments, the cutter 270 is positioned on, attached to, and/or removably couplable to the seal 280.

The coupler 260 can be configured to couple with or mate to an external receptacle, e.g., in any suitable manner, to facilitate transfer of the sample (e.g., sample 110, or sample portion 104) from the sample compartment 220, through the port 230, and into the external receptacle. The coupler 260, for example, can be or include one or more of a groove, surface, thread, interference fit and/or other feature of the housing 210. For example, the coupler 260 is configured to couple the device 200 to an external receptacle, e.g., a specimen or test tube, not shown, such that the sample portion 104 containing the sample 110 can be transferred from the sample compartment 220 to the external receptacle while preserving sterility or otherwise without exposing the sample 110 to the ambient environment and/or contamination from the operator. In some embodiments, for example, the coupler 260 is defined by a threaded surface of the device 200 and/or a threaded surface of the housing 210. The threaded surface can be configured to engage (e.g., rotatably) with a threaded surface of the external receptacle to facilitate coupling of the external receptacle to the device 200. Any suitable number or arrangement of threads can be included. In some embodiments, for example, the threads can be configured to facilitate about a ⅓ or about 120 degrees turn, for coupling and decoupling. In some embodiments, the port 230 includes or defines the coupler 260. In some embodiments, the coupler 260 couples to the external receptacle via a press-fit connection, a snap fit connection, etc. The external receptacle (not shown) can be any suitable device configured to receive and contain the sample substrate, e.g., for subsequent testing. In some embodiments, for example, the external receptacle is a test tube.

When the coupler 260 couples the external receptacle to the device 200, the sample portion 104 is sealed, e.g., fluidically sealed, and/or otherwise separated from the ambient environment, e.g., including users of the device 200. Thus, the coupler 260 is configured to preserve sterility and quality of the sample 110 during transfer of the sample portion 104 from the device 200 to the external receptacle. In some embodiments, the coupler 260 is aligned with and/or adjacent to the port 230 such that the sample portion 104 passes through the port 230 as the sample portion 104 is transferred from the sample compartment 220 to the external receptacle. In other words, the sample portion 104 can pass through the port 230 and the coupler 260 as the sample portion 104 is transferred from the sample compartment 220 to the external receptacle.

In some embodiments, the device 200 is configured to be at least partially inverted and/or tilted to facilitate the transfer of the sample portion 104 from the sample compartment 220 to the external receptacle. In use, for example, the device 200 may be inverted, e.g., maneuvered to an upside-down position, such that gravity causes the sample portion 104 to transfer to, e.g., drop into, the external receptacle coupled to the device 200. In some embodiments, the sample compartment 220 is movable relative to the other components of the device 200, e.g., the housing 210, the desiccant compartment 240, etc., such that the sample compartment 220 can be inverted, tilted, etc., to transfer the sample portion 104 to the external receptacle. In this manner, the sample portion 104 can be transferred from the sample compartment 220 to the external receptacle without additional tools, e.g., tweezers to grab the sample portion 104, and without exposing the sample portion 104 to potential contamination outside the secured collective volume within the sample compartment 220 and external receptacle.

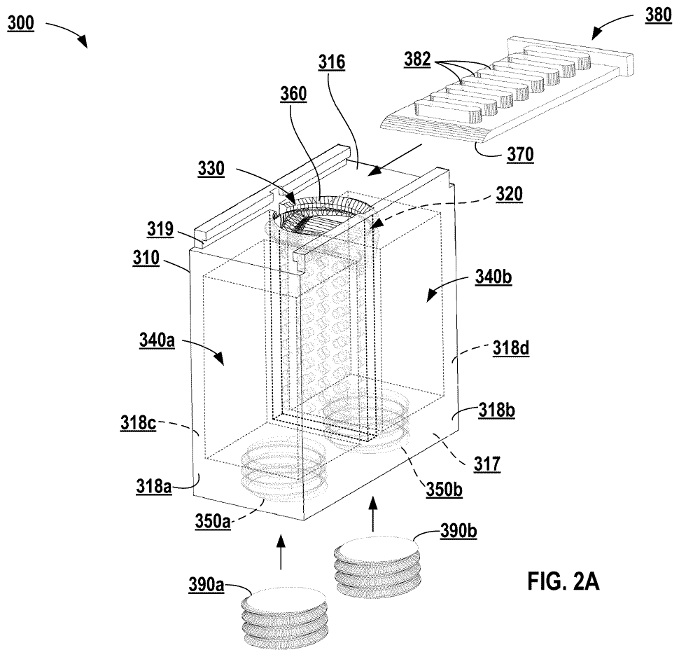

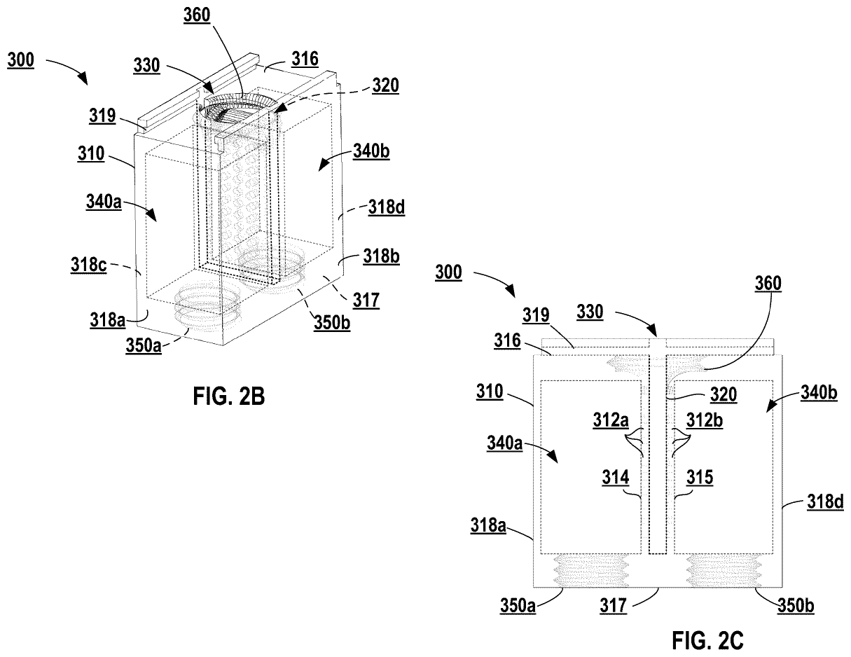

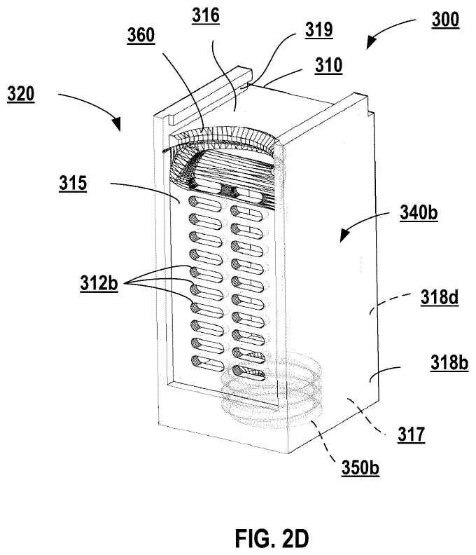

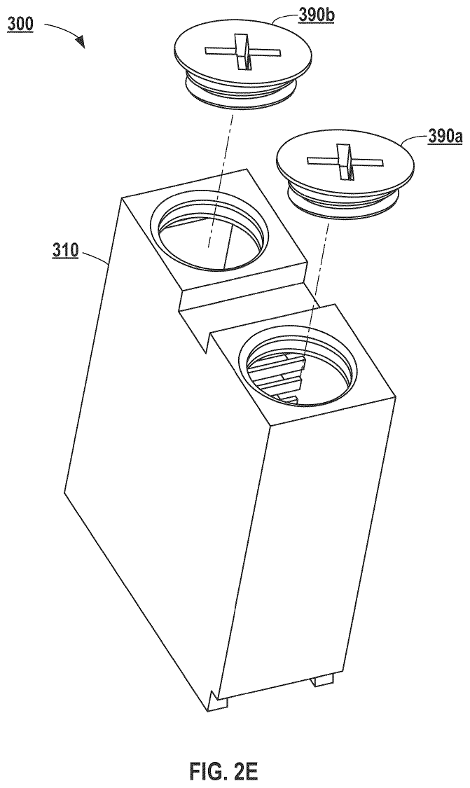

FIG. 2A is a perspective view of a biological fluid storage device 300 (also referred to herein as “device”) in a disassembled configuration, according to an embodiment. FIG. 2B is a perspective view of a portion of the device 300 of FIG. 2A, without the plugs and seal; FIG. 2C is a side view of the portion of the device 300 of FIG. 2B; FIG. 2D is a perspective, cutaway view of the portion of the device 300 of FIG. 2B; and FIG. 2E is another perspective view of a bottom of the device 300 of FIG. 2A. The device 300 can store, dry, preserve, and enable transport of biological fluid samples, e.g., the sample 110. The device 300 of FIGS. 2A-2E can be structurally and/or functionally the same or similar to the device 200 of FIG. 1B. For example, the device 300 includes a housing 310, e.g., structurally and/or functionally similar to the housing 210 of FIG. 1B, a sample compartment 320, e.g., structurally and/or functionally similar to the sample compartment 220 of FIG. 1B, a port 330, e.g., structurally and/or functionally similar to the port 230 of FIG. 1B, a first desiccant compartment 340a, e.g., structurally and/or functionally similar to the desiccant compartment 240 of FIG. 1B, a first port 350a, e.g., structurally and/or functionally similar to the port 250 of FIG. 1B, a coupler 360, e.g., structurally and/or functionally similar to the coupler 260 of FIG. 1B, a cutter 370, e.g., structurally and/or functionally similar to the cutter 270 of FIG. 1B, a seal 380, e.g., structurally and/or functionally similar to the seal 280 of FIG. 1B, and a seal 390a, e.g., structurally and/or functionally similar to the seal 290 of FIG. 1B. Further, the device 300 includes a second desiccant compartment 340b, e.g., structurally, and/or functionally similar to the desiccant compartment 240 of FIG. 1B, a second port 350b, e.g., structurally, and/or functionally similar to the port 250 of FIG. 1B, and a second seal 390b, e.g., structurally, and/or functionally similar to the seal 290 of FIG. 1B.

The sample compartment 320 is positioned between the first and second desiccant compartments 340a, 340b. As such, desiccant (not shown) disposed in at least one of the first desiccant compartment 340a or the second desiccant compartment 340b can cause a transfer of moisture from a sample, e.g., the sample 110, in the sample compartment 320 and/or moisture from the sample compartment 320 to the at least one of the first desiccant compartment 340a or the second desiccant compartment 340b. As shown in at least FIGS. 2C and 2D, this transfer can be facilitated by slots 312a in a wall 314 that separates the sample compartment 320 from the first desiccant compartment 340a and/or slots 312b in a wall 315 that separates the sample compartment 320 from the second desiccant compartment 340b. The slots 312a, 312b are shown in this embodiment to be arranged in a grid-like pattern on the respective walls 314, 315, however in some embodiments the slots 312a, 312b may be arranged in any suitable manner to facilitate the transfer of moisture. Further, the slots 312a, 312b are generally ovular in shape. However, the slots 312a, 312b can be rectangular, circular, or any suitable shape. Further, the slots 312a, 312b can be any suitable size (e.g., length, width, height, etc.) to facilitate fluid communication between the compartments 320, 340a, 340b. In some embodiments, the slots 312a, 312b may be larger or smaller than depicted in FIGS. 2A-2D.

The port 330 extends from an external surface 316 of the housing 310 to the sample compartment 320 to enable access thereto. In this embodiment the port 330 includes the coupler 360, which in this implementation is a threaded surface, to enable a threaded connection with the coupler 360, and thereby the device 300, with an external receptacle (e.g., a test tube; not shown). The seal 380 is movable and/or slidable across the external surface 316 to cover and/or seal the port 330. As shown in FIG. 2A, the cutter 370 is integral to the seal 380. In particular, a leading edge of the seal 380 defines the cutter 370. In use, when the sample portion 104 (not shown) is positioned within the sample compartment 320 and the user handling portion 102 is extending away from the external surface 316, the seal 380 can be moved and/or slid across the external surface 316 to align and enable contact between the cutter 370 and the interface 106 (not shown). As the seal 380 continues across the external surface 316, the cutter 370 contacts the interface 106 to separate the sample portion 104 from the user handling portion 102 (not shown). In turn, the sample portion 104 drops into the sample compartment 320 and the user handling portion 102 can be disposed, discarded, etc. As shown in FIG. 2A, the seal 380 can include ridges 382, e.g., ribs, grips, etc., to provide a grip for a user or a tool manipulated by a user to selectively open or close, seal or unseal, the sample compartment 320. In some embodiments, the seal 380 engages with a rail 319 of the housing 310 to facilitate sealing or unsealing. As best shown in at least FIG. 2A, the seal 380 can be positioned between the rail 319 and the external surface 316, e.g., as the seal 380 moves and/or slides across the external surface 316, to seal or unseal the sample compartment 320. Further, the rail 319 can secure a position of the seal 380 when the seal 380 is in the sealed configuration.

The first and second ports 350a, 350b enable access to the respective first and second desiccant compartments 340a, 340b. In FIG. 2A, the first and second ports 350a, 350b are positioned on a surface 317 opposing the external surface 316 of the housing 310. In some embodiments, the first and second ports 350a, 350b may be positioned in any location on the housing 310 adjacent to the respective first and second desiccant compartments 340a, 340b. For example, the first port 350a may be positioned on a first side 318a of the housing 310, a second side 318b of the housing 310, a third side 318c of the housing 310 opposing the second side 318b, the surface 317, or the external surface 316. Similarly, the second port 350b may be positioned on the second side 318b of the housing 310, the third side 318c of the housing 310, a fourth side 318d of the housing 310 opposing the first side 318a, the surface 317, or the external surface 316.

In this embodiment the first and second seals 390a, 390b are first and second plugs 390a, 390b, respectively. The first plug 390a couples to the first port 350a to seal the first desiccant compartment 340a. As shown in FIG. 2A, the first plug 390a includes a threaded surface and the first port 350a includes a threaded surface configured to be threadedly coupled with the threaded surface of the first plug 390a. As such, the first plug 390a may be coupled to the first port 350a by a threaded connection to facilitate sealing of the first desiccant compartment 340a. Similarly, the second plug 390b couples to the second port 350b to seal the second desiccant compartment 340b. As shown in FIG. 2A, the second plug 390b includes a threaded surface and the second port 350b includes a threaded surface configured to be threadedly coupled with the threaded surface of the second plug 390b. As such, the second plug 390b may be coupled to the second port 350b by a threaded connection to facilitate sealing of the second desiccant compartment 340b. In FIG. 2A, the first and second plugs 390a, 390b are similarly shaped and sized such that the first plug 390a can couple to the first port 350a or the second port 350b and/or the second plug 390b can coupled to the first port 350a or the second port 350b. In some embodiments, a size and/or shape of the first plug 390a may be different from the second plug 390b based on a size and/or shape of the corresponding first and second ports 350a, 350b. The first plug 390a and/or the second plug 390b may be removed from the respective first and second ports 350a, 350b to enable disposal of desiccant within the first desiccant compartment 340a and/or the second desiccant compartment 340b. Although in this embodiment the first and second plugs 390a, 390b are shown and described as having threads and being threadably insertable into the first and second ports 350a, 350b, in some embodiments, the plugs can be any suitable shape and contain any suitable coupling feature to selectively secure and/or seal the first and second desiccant compartments 340a, 340b. In some embodiments, for example, the plugs can be replaced by a component similar to the seal 280 or seal 380, and e.g., can be configured to be selectively slidable relative to first and second ports 350a, 350b.

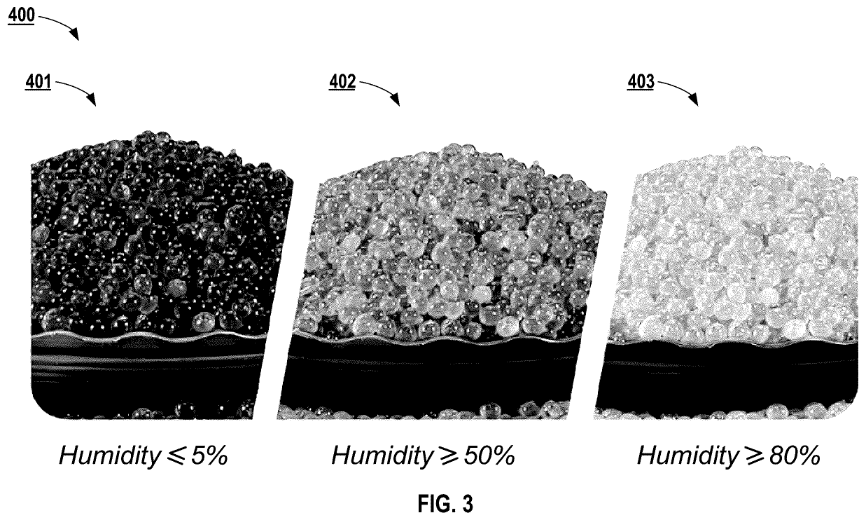

FIG. 3 shows desiccant 400 that can be included in biological fluid storage devices described herein (e.g., the device 200 of FIG. 1B, the device 300 of FIGS. 2A-2E, etc.), according to an embodiment. In particular, the desiccant 400 can be inserted through the first port 350a to enter the first desiccant compartment 340a (see FIGS. 2A-2D) and/or the second port 350b to enter the second desiccant compartment 340b (see FIGS. 2A-2D). Further, the first and second plugs 390a, 390b can seal the desiccant 400 in the corresponding first and second desiccant compartments 340a, 340b. As shown in FIG. 3, the desiccant 400 can change color, hue, shading, etc., as the desiccant 400 absorbs moisture, e.g., from the sample portion 104 in the sample compartment 220, from the ambient environment before the desiccant compartments 340a, 340b and/or the sample compartment 320 are sealed, and/or from any moisture existing in the housing 310 prior to use. For example, at a first level of moisture 401, e.g., less than or equal to 5%, the desiccant 400 exhibits a first color, e.g., blue, a second level of moisture 402, e.g., less than or equal to 50%, the desiccant 400 exhibits a second color, e.g., purple, and a third level of moisture 403, e.g., less than or equal to 80%, the desiccant 400 exhibits a third color, e.g., pink. In some embodiments, as humidity increases, the desiccant can absorb more moisture and can change color.

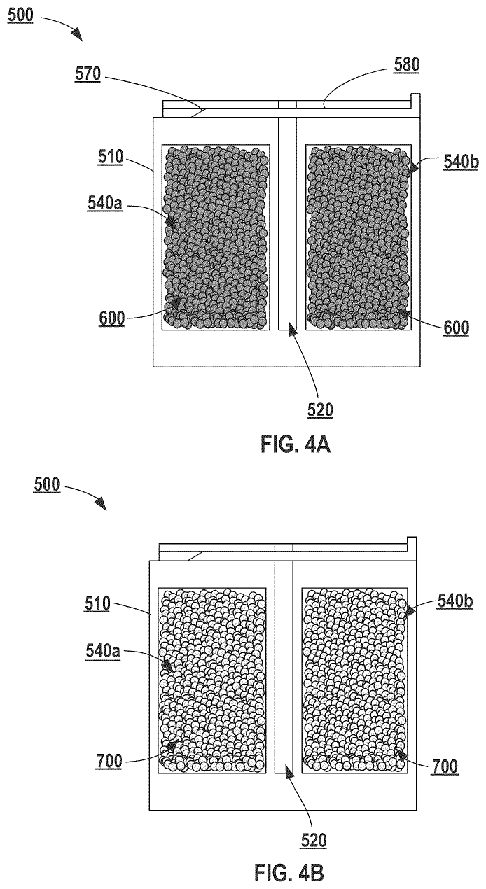

FIG. 4A shows a biological fluid storage device 500 (also referred to herein as “device’), according to an embodiment. The biological fluid storage device 500 of FIG. 4A can be structurally and/or functionally similar to any of the devices described herein, e.g., the device 200 of FIG. 1B and/or the device 300 of FIGS. 2A-2E. The desiccant compartments 540a, 540b are configured to contain desiccant 600 (e.g., structurally, and/or functionally similar to the desiccant 400 of FIG. 3). In the example of FIG. 4A, the housing 510 is sufficiently transparent to enable a color or a change in color of the desiccant 600 to be visible from outside the device 500. In this manner, a user can visually inspect the quality or capability (e.g., moisture level, concentration level) of the desiccant.

FIG. 4B shows the biological fluid storage device 500 with desiccant 700 having a different color or shade than the desiccant 600. As such, the desiccant 600 or the desiccant 700 may have absorbed a threshold amount of moisture (e.g., from a sample disposed in the sample compartment 520 and/or from the ambient environment).

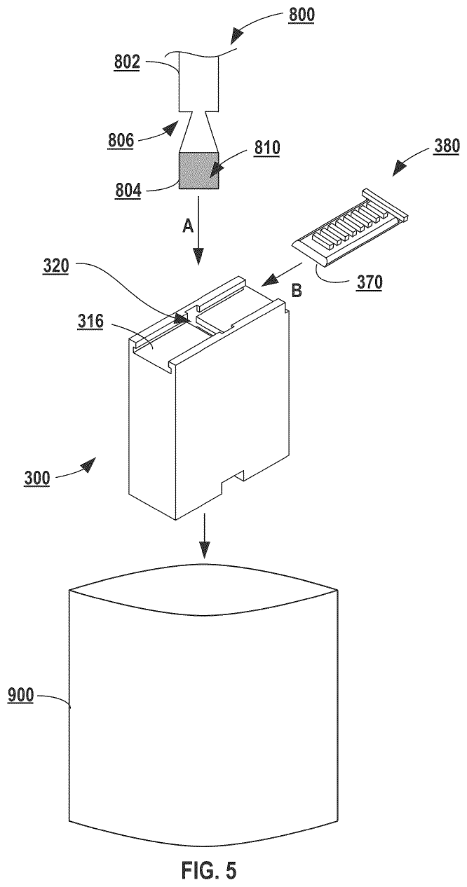

FIG. 5 is a flow diagram showing a loading process of the device 300 of FIGS. 2A-3A, according to an embodiment. The process includes a substrate 800, e.g., structurally, and/or functionally the same as or similar to the substrate 100 of FIG. 1A. The substrate 800 includes a user handling portion 802, an interface 806, and a sample portion 804 having a sample 810. The interface 806, in this embodiment, meets two tapered edges of the substrate 800 such that the interface 806 is narrower and, thus, weaker than the user handling portion 802 and the sample portion 804, and/or easier to cut. In turn, a user of the substrate 800 grabs, e.g., via hands or a tool, the user handling portion 802 to manipulate the sample portion 804 carrying the sample 810 into the sample compartment 320 of the device 300, in the direction shown by arrow A. With the sample portion 804 disposed within the sample compartment 320 and the user handling portion 802 extending away from the external surface 316, the interface 806 is aligned along a cutting plane of the cutter 370, and so a user can move the seal 380 across the external surface 316 (in the direction shown by arrow B). The cutter 370 contacts the interface 806 to separate the sample portion 804 from the user handling portion 802. The sample portion 804 is contained within the sample compartment 320. The user handling portion 802 can be discarded. Further, the seal 380 can continue to traverse the external surface 316 such that the seal 380 covers and, subsequently, seals the sample compartment 320 to isolate the sample portion 804 from the ambient environment. In turn, the sealed device 300 is positioned and sealed within a packaging 900 for transportation to a facility for subsequent testing of the sample 810 on the sample portion 804.

In some embodiments, the packaging 900 can be formed of one or more materials configured to protect (e.g., seal) one or more components disposed therein, e.g., from physical contact or damage, contamination, moisture, dropping, extreme temperature, sunlight, and/or similar factors that may compromise such component(s). In some embodiments, for example, the packaging 900 may include or be formed of a polyester film, such as, e.g., biaxially-oriented polyethylene terephthalate (BoPET), e.g., Mylar®. In some implementations, the packaging 900 can be a Mylar® bag. In some embodiments, the packaging 900 can include identifying information, e.g., an address, a barcode, patient identifier, test identifier, lab identifier, etc.

In some embodiments, the packaging 900 and/or the components disposed therein can be configured to meet certain shipping requirements or parameters, e.g., for cost savings purposes. Such packaging 900, for example, may be designed meet certain thickness, length, width, shape, and/or flexibility parameters. As an example, the United States Postal Service (USPS) offers relatively inexpensive shipping services for items that fit within and meet the requirements for a flat (also referred to by USPS as (large envelope”)). Some such requirements include a height between 6-⅛″ and 12″, length between 11-½″ and 15″, and a thickness between ¼″ and ¾″. Other flat requirements include certain flexibility and deflection parameters, and a uniform thickness (allowing only ¼″ variance in thickness, excluding the outer edges when the contents do not extend to the edges. In some embodiments, content(s) may be added to the packaging 900 to meet one or more of the shipping requirements, such as flexibility and/or uniform thickness. In some such embodiments, for example, the packaging may include foam, cardboard, and/or similar material adjacent to and/or around the device (e.g., device 300). In some instances, such additional content can allow the packaging 900 to meet the overall flexibility requirements even when the device (e.g., device 300) is relatively rigid or inflexible.

In some embodiments, the packaging 900 includes at least one of a height in a range from about 6 inches (in.) to about 12 in., a length in a range from about 11 in. to about 15 in., or a thickness in a range from about ¼ in. to about ¾ in. In some embodiments, the packaging 900 includes or encloses a foam material and/or a cardboard material. For example, the sealed device 300 may be surrounded by and/or wrapped in the foam material and/or the cardboard material when the sealed device 300 is positioned in the packaging 900. In some embodiments, the sample portion 804 configured to carry the sample 810, the sealed device 300, and the packaging 900 can define or being included in a kit, as described in further detail herein.

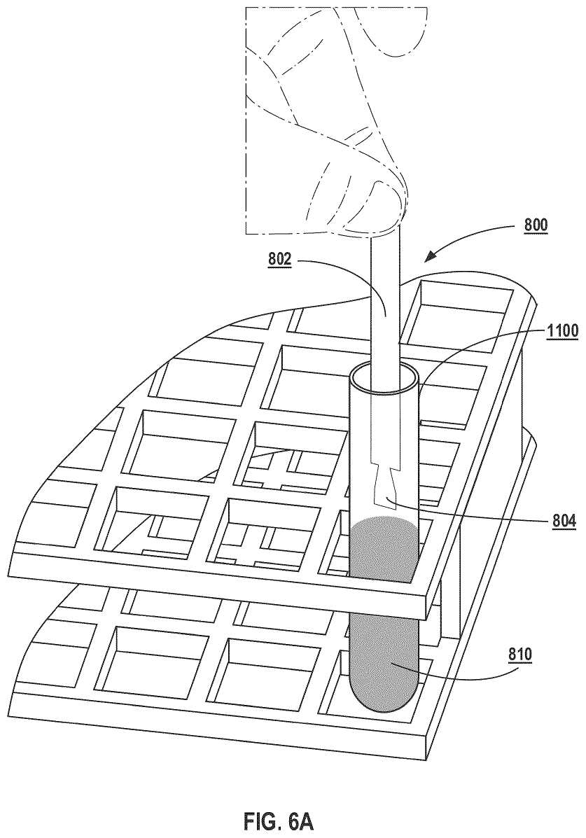

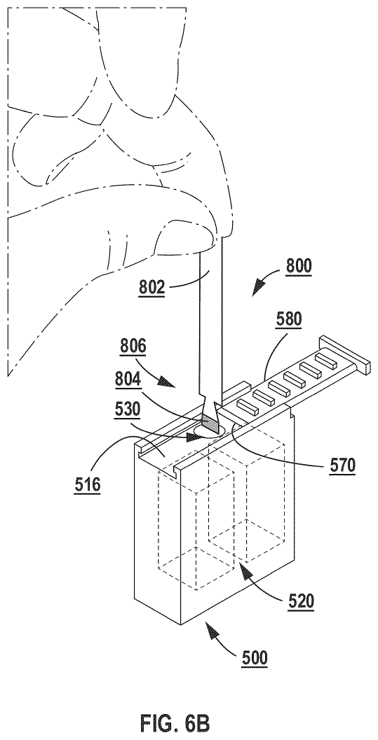

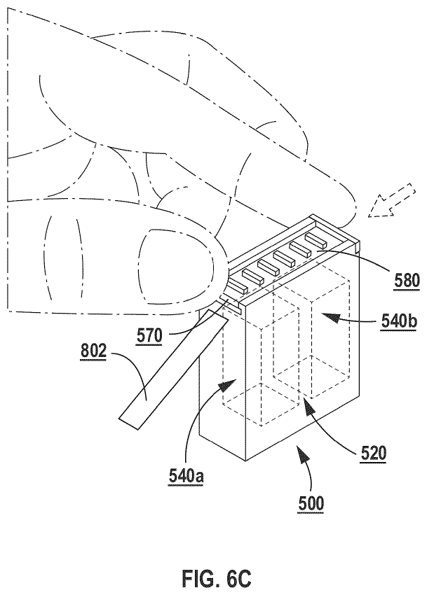

FIGS. 6A-6C show a sample collection process (also referred to as “process”) of the device 500, according to an embodiment. As shown in FIG. 6A, the substrate 800 is lowered into a test tube 1100 carrying the sample 810 such that the sample portion 804 contacts and retrieves the sample 810, e.g., via absorption. The fingers of the user contact and manipulate the user handling portion 802 to insert the sample portion 804 into the test tube 1100. As shown in FIG. 6B, the user manipulates the user handling portion 802 to position the sample portion 804 carrying the sample 810 into the sample compartment 520. The seal 580 is moved from an unsealed configuration (FIG. 6B) to a sealed configuration (FIG. 6C). When the interface 806 is properly aligned, e.g., adjacent to and/or external to the port 530, the user can push the seal 580 across the external surface 516 (e.g., by engaging with a rail such as the rail 319 of FIGS. 2A-2D) such that the cutter 570 contacts the interface 806. As shown in FIG. 6C, this movement of the seal 580 and, thus, the movement of the cutter 570, caused the user handling portion 802 to separate from the sample portion 804. The sample portion 804 is sealed in the sample compartment 520 based on the seal 580 covering the port 530 (see FIG. 6B). In some embodiments, the device 500 is preloaded with desiccant in the desiccant compartments 540a, 540b, e.g., prior to sealing the sample portion 804 within the sample compartment 520. Alternatively, the desiccant may be disposed within the desiccant compartments 540a, 540b after the sample portion 804 is sealed within the sample compartment 520.

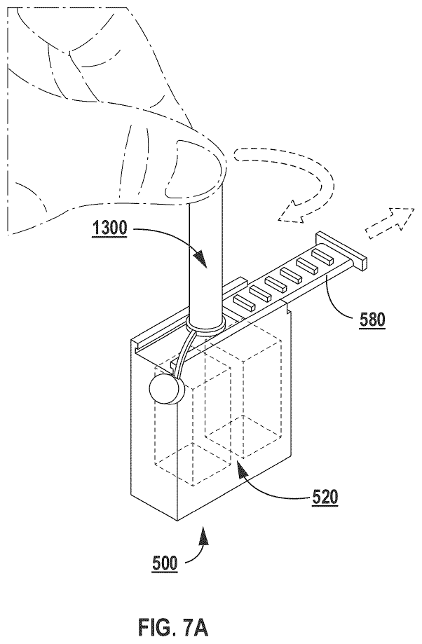

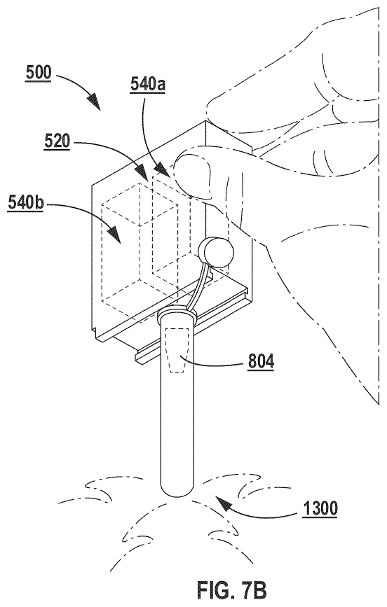

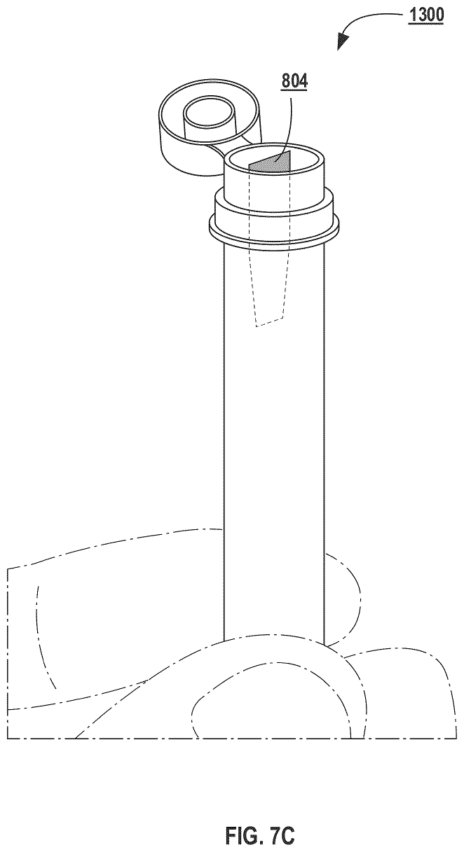

FIGS. 7A-7C show a substrate retrieval process (also referred to as “process”) of the device 500, according to an embodiment. The process begins in FIG. 7A, at which the seal 580 is maneuvered to unseal the sample compartment 520. Further, an external receptacle 1300 (in this implementation, a test or specimen tube) engages with the device 500 via a coupler (not shown), e.g., structurally, and/or functionally similar to the coupler 260 of FIG. 1B. The sample portion 804 is sealed within the sample compartment 520 when the external receptacle 1300 engages with the device 500. As shown in FIG. 7B, the device 500 and the external receptacle 1300 coupled to the device 500 are inverted to cause the sample portion 804 to move from the sample compartment 520 to the external receptacle 1300, e.g., via gravity and/or by tapping the receptacle 1300 against a surface. In some embodiments, the device 500 and the external receptacle 1300 are inverted after an observation of a change in color of the desiccant in the desiccant compartments 540a, 540b. As shown in FIG. 7C, the device 500 is decoupled from the external receptacle 1300, leaving the sample portion 804 contained within the external receptacle 1300 for subsequent transportation and/or testing of the sample 810 (not shown). In some embodiments, the sample portion 804 can include a triangular shape configured to fit into or mate with a similarly (e.g., but oppositely oriented) triangular shaped cavity associated with the external receptacle 1300.

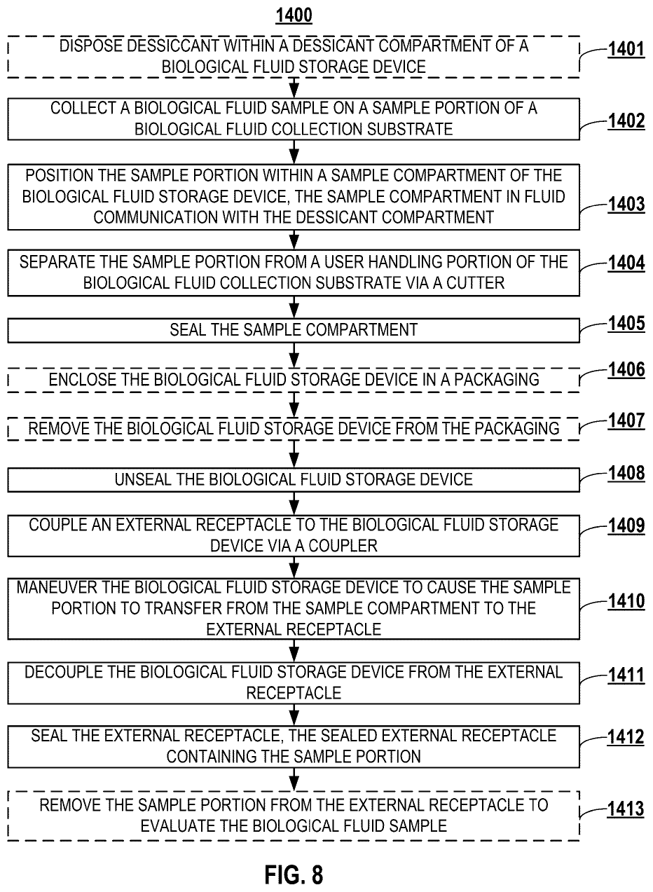

FIG. 8 is a flowchart of an example method 1400 of operating and/or using the biological fluid storage device 200, according to an embodiment. However, the method 1400 can describe a method of operating and/or using any biological fluid storage device, such as those described herein. Optionally, at 1401, the method 1400 includes disposing desiccant within the desiccant compartment 240 of the biological fluid storage device 200. At 1402, the biological fluid sample 110 is collected on the sample portion 104 of the biological fluid collection substrate 100. At 1403, the sample portion 104 is positioned within the sample compartment 220 of the biological fluid storage device 200, the sample compartment 220 being in fluid communication with the desiccant compartment 240. At 1404, the sample portion 104 is separated from the user handling portion 102 of the biological fluid collection substrate 100 via the cutter 270. At 1405, the sample compartment 220 is sealed, e.g., via the seal 280.

Optionally, at 1406, the biological fluid storage device 200 is enclosed in a packaging, e.g., the packaging 900. For example, the device 200 is enclosed in the packaging 900 such that the packaging 900 carrying the sealed device 200 is transportable, e.g., via USPS. Optionally, at 1407, the biological fluid storage device 200 is removed from the packaging, e.g., at a laboratory or other testing facility. At 1408, the biological fluid storage device 200 is unsealed. At 1409, an external receptacle, e.g., the external receptacle 1300, is coupled to the biological fluid storage device 200 via the coupler 260. At 1410, the biological fluid storage device 200 is maneuvered, e.g., inverted, to cause the sample portion 104 to transfer from the sample compartment 220 to the external receptacle. At 1411, the external receptacle is decoupled from the biological fluid storage device 200. At 1412, the external receptacle is sealed, the sealed external receptacle containing the sample portion 104. Optionally, at 1413, the sample portion 104 is removed from the external receptacle to evaluate the biological fluid sample 110.

While various embodiments have been described above, it should be understood that they have been presented by way of example only, and not limitation. While the embodiments have been particularly shown and described, it will be understood that various changes in form and details may be made. Where schematics and/or embodiments described above indicate certain components arranged in certain orientations or positions, the arrangement of components may be modified. Although various embodiments have been described as having particular features and/or combinations of components, other embodiments are possible having a combination of any features and/or components from any of embodiments as discussed above.

1. A biological fluid storage device, comprising:
a sample compartment configured to contain a sample portion of a biological fluid collection substrate containing a biological fluid sample;
a desiccant compartment in fluid communication with the sample compartment and configured to contain a desiccant such that moisture is encouraged to transfer from at least one of the sample compartment or the sample portion in the sample compartment, to the desiccant in the desiccant compartment; and
a coupler configured to couple the storage device to an external receptacle such that the sample portion containing the sample can be transferred from the sample compartment to the external receptacle.

2. The biological fluid storage device of claim 1, wherein the coupler includes a threaded surface configured to engage with a threaded surface of the external receptacle to facilitate coupling of the external receptacle to the storage device.

3. The biological fluid storage device of claim 1, wherein the sample portion is sealed from an ambient environment external to the storage device when the external receptacle is coupled to the storage device.

4. The biological fluid storage device of claim 1, further including a seal configured to selectively or reversibly seal the sample compartment from an ambient environment external to the storage device.

5. The biological fluid storage device of claim 4, wherein the seal is configured to seal the biological fluid sample from the ambient environment when the sample compartment contains the sample portion.

6. The biological fluid storage device of claim 4, wherein the seal is configured to cover a port of the sample compartment to seal the sample portion from the ambient environment.

7. The biological fluid storage device of claim 4, wherein the seal further includes a cutter configured to separate the sample portion from a remainder of the biological fluid collection substrate.

8. The biological fluid storage device of claim 1, further comprising a cutter configured to separate the sample portion from a remainder of the biological fluid collection substrate.

9. The biological fluid storage device of claim 8, wherein the cutter is positioned on a seal of the biological fluid storage device.

10. The biological fluid storage device of claim 1, wherein the sample compartment is configured to be at least partially inverted to facilitate transfer of the sample from the sample compartment to the external receptacle.

11. The biological fluid storage device of claim 1, further including a housing defining the sample compartment and the desiccant compartment, wherein a portion of the housing is transparent, the portion being adjacent to the desiccant compartment such that at least some of the desiccant is visible through the portion of the housing.

12. The biological fluid storage device of claim 11, wherein the portion of the housing surrounds the desiccant compartment.

13. A biological fluid storage device, comprising:
a cutter configured to separate a sample portion of a biological fluid collection substrate containing a biological fluid sample from a user handling portion of the substrate;
a sample compartment configured to contain the sample portion containing the fluid sample; and
a desiccant compartment in fluid communication with the sample compartment and configured to contain a desiccant such that moisture is encouraged to transfer from at least one of the sample compartment or the sample portion in the sample compartment, to the desiccant in the desiccant compartment.

14. The biological fluid storage device of claim 13, further including a seal to cover the sample compartment, wherein the cutter is integral to or defined by the seal.

15. The biological fluid storage device of claim 14, wherein the cutter is a sharp edge of the seal.

16. The biological fluid storage device of claim 14, wherein the sample compartment further includes a port configured to facilitate positioning of the sample portion in the sample compartment,
wherein the cutter is movable relative to the port such that the cutter is configured to contact an interface between the user handling portion and the sample portion to separate the user handling portion from the sample portion when the sample portion is positioned within the sample compartment.

17. The biological fluid storage device of claim 16, wherein the interface includes perforations to facilitate separation of the sample portion and the user handling portion.

18. The biological fluid storage device of claim 16, wherein the port is aligned with the interface when the sample portion is positioned within the sample compartment.

19. (canceled)

20. A method, comprising:
removing a biological fluid collection storage device from a packaging, the biological fluid collection storage device including:
a sample compartment with a sample substrate positioned therein, the sample substrate containing a biological fluid sample, and
a desiccant compartment with a desiccant positioned therein, the desiccant compartment in fluid communication with the sample compartment to cause the desiccant to absorb moisture from the sample substrate,
coupling an external receptacle to the biological fluid collection storage device via a coupler; and
maneuvering the sample compartment to cause the sample substrate to transfer from the sample compartment to the external receptacle.

21. The method of claim 20, wherein the maneuvering excludes direct physical contact with the sample substrate.

22. (canceled)
